(19) United States
(12) Patent Application Publication
(10) Pub. No.: US 2008/0091415 A1
(43) Pub. Date: Apr. 17, 2008

(54) System and method for canceling acoustic echoes in audio-conference communication systems

(76) Inventor: Ronald W. Schafer, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/546,680

(22) Filed: Oct. 12, 2006

(51) Int. Cl. G10L 19/00

(52) U.S. Cl. 704/200.1

(57) ABSTRACT

Various embodiments of the present invention are directed to a frequency-domain coder/decoder for an audio-conference communication system that includes acoustic-echo-cancellation functionality. In one embodiment of the present invention, an acoustic echo canceller is integrated into the frequency-domain coder/decoder and ameliorates or removes acoustic echoes from audio signals that have been transformed to the frequency domain and divided into subbands by the frequency-domain coder/decoder.

### TECHNICAL FIELD

The present invention relates to acoustic echo cancellation, and, in particular, to a system and method for canceling acoustic echoes in audio-conference communication systems.

### BACKGROUND OF THE INVENTION

Popular communication media, such as the Internet, electronic presentations, voice mail, and audio-conference communication systems, are increasing the demand for better audio and communication technologies. Currently, many individuals and businesses take advantage of these communication media to increase efficiency and productivity, while decreasing cost and complexity. Audio-conference communication systems allow one or more individuals at a first location to simultaneously converse with one or more individuals at other locations through full-duplex communication lines, without wearing headsets or using handheld communication devices. Typically, audio-conference communication systems include a number of microphones and loudspeakers at each location. These microphones and loudspeakers can be used by multiple individuals for sending and receiving audio signals to and from other locations. When digital communication systems are used for transmission of audio signals, coder/decoders are often integrated into audio-conference communication systems for compressing audio signals before transmission and uncompressing audio signals after transmission.

Modern audio-conference communication systems attempt to provide clear transmission of audio signals, free from perceivable distortion, background noise, and other undesired audio artifacts. One common type of undesired audio artifact is an acoustic echo. Acoustic echoes can occur when a transmitted audio signal loops through an audio-conference communication system due to a coupling of microphones and speakers. For example, when an audio signal is transmitted from a microphone at a first location to a loudspeaker at a second location, the audio signal may pass to a coupled microphone at the second location and may be transmitted back to a loudspeaker at the first location. In such a case, a person speaking into the microphone at the first location may hear a delayed echo of the originally transmitted audio signal. Depending on the signal amplification, or gain, and the proximity of the microphones to the speakers at each location, the person speaking into the microphone at the first location may even hear an annoying howling sound.

Designers of audio-conference communication systems have attempted to compensate for acoustic echoes in various ways. One compensation technique employs a filtering system to cancel echoes, referred to as an “acoustic echo canceller.” Acoustic echo cancellers attempt to cancel acoustic echoes before acoustic echoes reach the sender of the original audio signal. Typically, acoustic echo cancellers employ adaptive filters that adapt to changing conditions at an audio-signal-receiving location that may affect the characteristics of acoustic echoes. However, adaptive filters are often slow to adjust to changing conditions, because adaptive filters generally perform a large number of calculations to adjust filter performance. Designers, manufacturers, and users of audio-conference communication systems have, therefore, recognized a need for an acoustic echo canceller that can more quickly adapt to changing conditions at an audio-signal-receiving location and efficiently cancel out undesired echoes in audio-conference communication systems.

### SUMMARY OF THE INVENTION

Various embodiments of the present invention are directed to a frequency-domain coder/decoder for an audio-conference communication system that includes acoustic-echo-cancellation functionality. In one embodiment of the present invention, an acoustic echo canceller is integrated into the frequency-domain coder/decoder and ameliorates or removes acoustic echoes from audio signals that have been transformed to the frequency domain and divided into subbands by the frequency-domain coder/decoder.

### BRIEF DESCRIPTION OF THE DRAWINGS

FIG. 1A shows a schematic diagram of an exemplary, two-location, audio-conference communication system.

FIG. 1B shows a schematic diagram of an exemplary, two-location, audio-conference communication system employing an acoustic echo canceller at one of the two locations.

FIG. 2 shows a block diagram depicting the general structure of a frequency-domain audio coder.

FIG. 3 shows a filter bank system suitable for performing frequency analysis of audio signals in the frequency-domain audio coder shown in FIG. 2.

FIG. 4 shows a block diagram depicting the general structure of a frequency-domain audio decoder suitable for use with the frequency-domain audio coder shown in FIG. 2.

FIG. 5 shows a filter bank system suitable for performing frequency synthesis of audio signals in the frequency-domain audio decoder shown in FIG. 4.

FIG. 6 shows a schematic diagram of the exemplary, two-location, audio-conference communication system shown in FIGS. 1A-1B employing an acoustic echo canceller and a frequency-domain coder/decoder.

FIG. 7 shows a more detailed schematic diagram of Room 1 of the exemplary, two-location, frequency-domain-coder/decoder-based audio-conference communication system shown in FIG. 6.

FIG. 8 shows a schematic diagram of an acoustic echo canceller that is integrated into a frequency-domain coder/decoder within Room 1 of an exemplary, two-location, audio-conference communication system and that represents one embodiment of the present invention.

FIG. 9A shows a schematic diagram of linear filtering followed by frequency analysis.

FIG. 9B shows a schematic diagram of frequency analysis followed by linear filtering of the subband signals so that the outputs of FIGS. 9A and 9B are equivalent.

### DETAILED DESCRIPTION OF THE INVENTION

One embodiment of the present invention is directed to an acoustic echo canceller, integrated within a frequency-domain coder/decoder and included in an audio-conference communication system. The acoustic echo canceller cancels acoustic echoes that are created when one or more loudspeakers are coupled to one or more microphones at an audio-signal-receiving location. Changing conditions at the audio-signal-receiving location cause a change in the impulse response between a coupled loudspeaker and microphone at the audio-signal-receiving location, which, in turn, causes a change in character of the acoustic echo. An adaptive filter within the acoustic echo canceller tracks the impulse response of the audio-signal-receiving location and creates an impulse response estimate. An echo signal estimate is created in the acoustic echo canceller using the impulse response estimate. The echo signal estimate is then subtracted from the signal propagating from the microphone at the audio-signal-receiving location, and the resulting error signal is output back to the audio-signal sending location.

The adaptive filter is implemented in the frequency domain by using the same frequency analysis and synthesis operation that are used to implement the coding and decoding of audio signals for compression of the audio signals. The adaptive filter inputs and outputs frequency-domain audio signals that are divided into a series of relatively-flat-spectrum subbands within the frequency-domain coder/decoder. The subband signals are sampled at a sampling rate much lower than a sampling rate typically used for full-band audio signals. Additionally, in alternate embodiments of the present invention, the acoustic echo canceller may incorporate already existing noise-reduction components and perceptual-coding components of the frequency-domain coder/decoder within the acoustic echo canceller and thereby improve echo-canceling performance.

The present invention is described below in the following three subsections: (1) an overview of acoustic echo cancellation; (2) an overview of audio signal compression; and (3) frequency-domain-acoustic-echo-canceller embodiments of the present invention.

### Overview of Acoustic Echo Cancellation

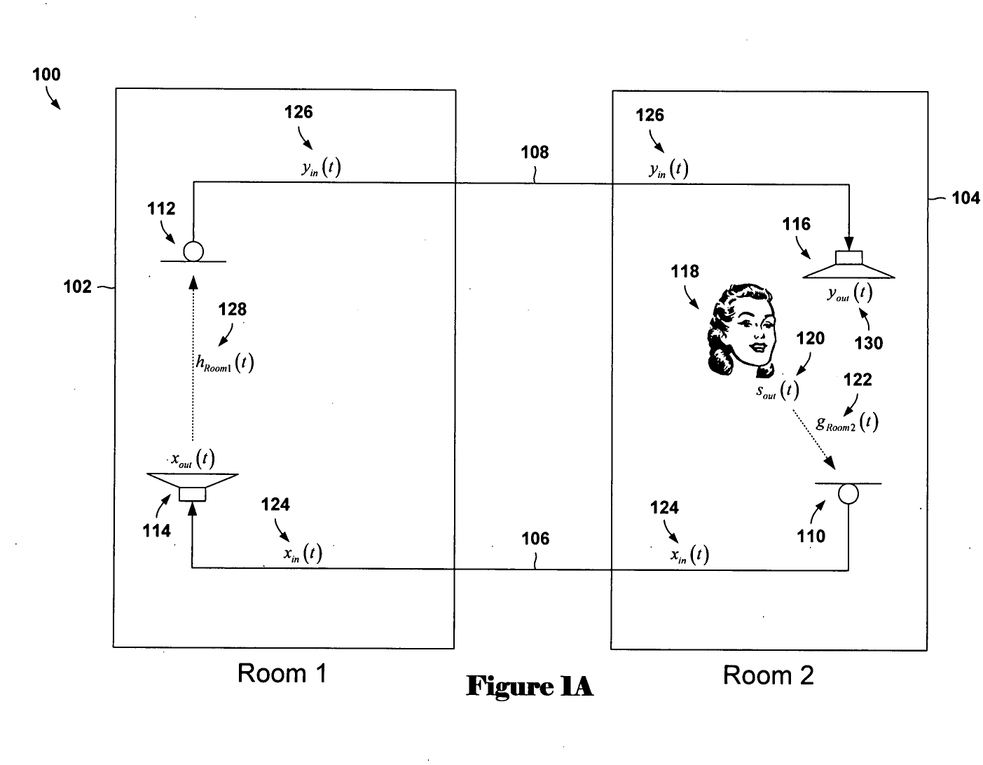

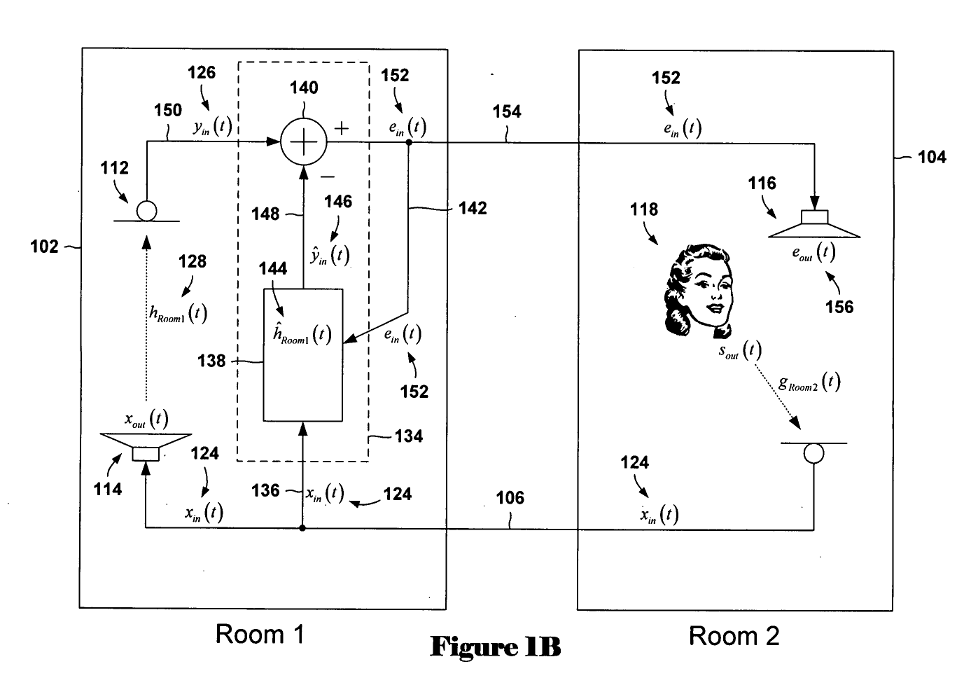

Acoustic echoes occur in audio-conference communication systems because of coupling between one or more microphones and one or more loudspeakers at one or more locations. FIG. 1A shows a schematic diagram of an exemplary, two-location, audio-conference communication system. Audio-conference communication system 100 includes two locations: Room 1 102 and Room 2 104. Audio signals are transmitted between Room 1 102 and Room 2 104 by communications media 106 and 108. Audio signals are input to the communications media by microphones 110 and 112, and audio signals are output from the communications media on loudspeakers 114 and 116.

In FIG. 1A, an audio-signal source 118 in Room 2 104 produces an audio signal sₒᵤₜ(t) 120. The subscript “out” is used with reference to several different signals in various figures throughout the current application to denote that the signal is being transmitted outside of the communication media, while the subscript “in” is used with reference to signals transmitted inside the communication media. The notation “(t)” is used with reference to several different signals in various figures throughout the current application to denote that the signal is a function of time. When discussing acoustic signals occurring inside Room 1 102 and Room 2 104, “(t)” represents continuous (analog) time. When discussing sampled signals, as used for digital transmission and digital signal processing, “(t)” represents discrete-time instants spaced at intervals (or multiples) of the sampling period Tₛ=1/fₛ

Audio signal sₒᵤₜ(t) 120 takes many paths inside Room 2 104. Some of the paths are received by microphone 110, either by a direct path, or by reflecting from objects inside Room 2 104. The different paths that audio signal sₒᵤₜ(t) 120 takes from audio-signal source 118 to the output of microphone 110 are collectively referred to as the impulse response of Room 2 104. In FIG. 1A, the impulse response of Room 2 104, g_{Room2}(t) 122, is represented by a dotted line pointing from audio-signal source 118 to microphone 110. Impulse response g_{Room2}(t) 122 can change as the conditions inside of Room 2 104 change. Examples of changes include movement of people, opening and closing of doors, and repositioning of furniture within Room 2 104. For simplicity of illustration, impulse response g_{Room2}(t) 122 is shown as a single line, but is generally a complex superposition of many different sound paths with many different directions.

Under normal conditions, the sound transmission in a room can be well modeled as a linear system. It is well known that linear systems are described mathematically by the operation of convolution. Accordingly, the audio signal xᵢₙ(t) 124, the output of microphone 110, is the result of a convolution, described below, between audio signal sₒᵤₜ(t) 120 and impulse response g_{Room2} (t) 122. In FIG. 1A, audio signal xᵢₙ(t) 124 can be expressed as:

xᵢₙ(t)=sₒᵤₜ(t)*g_{Room2}(t)=∫_{-∞}^{∞}sₒᵤₜ(Σ)g_{Room2}(t−τ)dτ

where
sₒᵤₜ(t) 120 is the audio signal output by audio-signal source 118,
g_{Room2}(t) 122 is the impulse response of Room 2 104,
xᵢₙ(t) 124 is the signal input to communication medium 106, and
“*” denotes continuous-time convolution.

### In the example above, g_{Room2}(t) 122 includes the microphone response, which is assumed linear, as well as the multi-path transmission of Room 2 104.

Audio signal xᵢₙ(t) 124 in Room 2 104 is passed from microphone 110, via communication media 106, to loudspeaker 114 in Room 1 102. The audio signal xᵢₙ(t) 124 passes through loudspeaker 114 (shown in FIG. 1A as audio signal “xₒᵤₜ(t)” while in Room 1 102) and then through Room 1 102 to microphone 112. The collective set of paths that audio signal xᵢₙ(t) 124 takes from loudspeaker 114 to the output yᵢₙ(t) 126 of microphone 112 is referred to as the impulse response of Room 1 102. In FIG. 1A, the impulse response of Room 1 102, h_{Room1}(t) 128, is represented by a dotted line pointing from loudspeaker 114 to microphone 112. For simplicity of illustration, impulse response h_{Room1}(t) 128 is shown as a single line, but is generally a complex superposition of many different sound paths with many different directions and reflections. Note that it is presumed that both the loudspeaker and microphone are linear systems whose response characteristics can be combined linearly with the multi-path Room 2 102 impulse response. The audio signal output from microphone 112, which is the echo signal yᵢₙ(t) 126, is the result of a convolution between audio signal xᵢₙ(t) 124 and impulse response h_{Room1}(t) 128. Note that when an audio signal originates in Room 1 102, such as when someone is speaking in Room 1 102, the audio signal is also picked up by microphone 112. When microphone 112 is picking up sounds transmitting from both an audio signal from Room 2 104 and an audio signal from Room 1 102, this condition is known as “double talk.” The double talk state is generally detected by acoustic echo cancellers and echo cancellation is suspended. Many double-talk-detection algorithms are known in the art of acoustic echo cancellation and can be applied as part of the control mechanism for the present invention.

Assuming that there are no audio signals originating from Room 1 102 that are being picked up by microphone 112, echo signal yᵢₙ(t) 126 can be expressed by:

yᵢₙ(t)=xᵢₙ(t)*h_{Room1}(t)=∫_{-∞}^{∞}xᵢₙ(Σ)h_{Room1}(t−τ)dτ

where
xᵢₙ(t) 124 is the audio signal input to loudspeaker 114,
h_{Room1}(t) 128 is the impulse response of Room 1 102,
yᵢₙ(t) 126 is the signal input to communication medium 108, and
“*” denotes continuous-time convolution.

Echo signal yᵢₙ(t) 126 is passed from microphone 112, via communication medium 108, to loudspeaker 116 in Room 2 104. Loudspeaker 116 outputs echo signal yₒᵤₜ(t) 130. When audio-signal source 118 is a person speaking, that person may hear a time-delayed echo of his or her voice while he or she is still talking. The time delay can vary, depending on a number of factors, such as the distance separating the Room 1 102 and Room2 104 and the amount of time needed by additional signal processing, such as a frequency-domain coder/decoder (not shown in FIG. 1A) employed by audio-conference communication system 100 to process the audio signals before and after digital transmission between locations. Depending on the amplifications of the audio signals by the microphones and the distance between the loudspeakers and the microphones, the person speaking into microphone 110 may hear a delayed echo of his or her voice, or when the loop gain is high enough, hear an annoying howling sound. Audio signal yₒᵤₜ(t) 130 may be received by microphone 110, thereby looping the acoustic echo through audio-conference communication system 100 indefinitely if something is not done to remove the acoustic echo.

FIG. 1B shows a schematic diagram of an exemplary, two-location, audio-conference communication system employing an acoustic echo canceller at one of the two locations. Acoustic echo canceller 134, represented in FIG. 1B by a dashed rectangle, receives sampled audio signal xᵢₙ(t) 124, via communication medium 136, which interconnects with communication medium 106. In FIG. 1B, the acoustic echo canceller appears as an analog system. However, adaptive filters for audio-conference communication systems are typically finite impulse response digital filters. For finite response digital systems, the audio signals are generally sampled and the convolutions are generally performed by numerical computation. Sampling and numerical computation can be achieved, for example, by using an analog-to-digital converter in Room 1 102 to sample yᵢₙ(t) 126 to produce a discrete-time signal. Likewise, an analog-to-digital converter in Room 2 104 can be used to produce a discrete-time version of the signal xᵢₙ(t) 124. In FIG. 1B, a digital-to-analog converter can be used to convert xᵢₙ(t) 124 into an analog signal to input to loudspeaker 114. Although the analog-to-digital converters and digital-to-analog converter are not shown in FIG. 1B, it is assumed in the above discussion that the signals in FIG. 1B are sampled at an appropriate sampling rate, that digital transmission is used between Room 1 102 and Room 2 104, and that digital filtering is used to implement echo cancellation.

Acoustic echo canceller 134 comprises adaptive filter 138 and summing junction 140. Adaptive filter 138 receives signals via two inputs. The first input receives audio signal xᵢₙ(t) 124 via communication medium 136, and the second input receives a feedback signal, the signal output from acoustic echo canceller 134, via communication medium 142. Adaptive filter 138 uses information contained in the two input signals to create impulse response estimate ĥ_{Room1}(t) 144 that adjusts to track impulse response h_{Room1}(t) 128 as impulse response h_{Room1}(t) 128 changes with changing conditions within Room 1 102. Audio signal xᵢₙ(t) 124 is convolved with impulse response estimate ĥ_{Room1}(t) 142 by the acoustic echo canceller 134 to produce echo signal estimate ŷᵢₙ(t) 146 by discrete convolution:

$${\hat{y}}_{in} ( t ) = {x}_{in} ( t ) * {\hat{h}}_{Room 1} ( t ) = {\sum }_{r = 0}^{M} {\hat{h}}_{Room 1} ( τ ) {x}_{in} ( t - τ ) .$$

Echo signal estimate ŷᵢₙ(t) 146 is passed, via communication medium 148, to summing junction 140, to which echo signal yᵢₙ(t) 126 is also input, via communication line 150, from microphone 112. Summing junction 140 subtracts echo signal estimate ŷᵢₙ(t) 146 from echo signal yᵢₙ(t) 126 to produce error audio signal eᵢₙ(t) 152, the signal to be transmitted to the Room 2 104:

eᵢₙ(t)=yᵢₙ(t)−ŷᵢₙ(t)=xᵢₙ(t)*h_{Room1}(t)−xᵢₙ(t)*ĥ_{Room1}(t)

Error audio signal eᵢₙ(t) 152 is passed, via communication line 154, to loudspeaker 116 and output to Room 2 104 as error signal eₒᵤₜ(t) 156. When impulse response estimate h_{Room1}(t) 144 is sufficiently close to impulse response h_{Room1}(t) 128, the error audio signal eᵢₙ(t) 152 has a small magnitude, and little acoustic echo is transmitted to Room 2 104. Note that during double talk situations, it is necessary to suspend adaptation of the adaptive filter 138 since, by linearity, the error signal also contains the speech signal of a person in Room 1 102 (not shown in FIG. 1B), and this can cause divergence of the adaptive filter 138. The acoustic echo canceller 134 can continue to attempt to cancel the acoustic echo produced by audio-signal source 118 in Room 2 104 using the most recently derived ĥ_{Room1}(t) 144, but because the system utilizes full-duplex operation, the speech of the person in Room 1 102 (not shown in FIG. 1B) is still transmitted to Room 2 104.

The filter-coefficient values ĥ_{Room1}(t) 144 for t=0, 1, 2, . . . , M determine the characteristics of the discrete-time filter. In the case of adaptable filters, the coefficients are adjusted over time. The filter coefficients are derived using well-known techniques in the art, such as the least mean squares algorithm (“LSM”) or affine projection. Such algorithms can be used to continually adapt the filter coefficients of the adaptive filter 138 to converge impulse response estimate ĥ_{Room1}(t) 144 with Room 1 102 impulse response h_{Room1}(t) 128. As previously discussed with reference to FIG. 1B, feedback is provided to adaptive filter 138 by communication medium 142, which connects to communication medium 154 and passes the most recent value for error audio signal eᵢₙ(t) 152 back to adaptive filter 138.

Note that the acoustic echo canceller described with reference to FIG. 1B operates only to cancel acoustic echoes derived from audio signals originating from Room 2 104. In most two-way conversations, audio signals are sent and received at each location. In order to cancel acoustic echoes originating from Room 1 102, a second acoustic echo canceller is generally employed in Room 2 104.

### Overview of Audio Signal Compression

A major component of digital telecommunication technologies, including audio-conference communication systems, is the storage of data and transfer of data from one location to another location. Because data storage and transmission can be expensive and time-consuming, various techniques have been created to more efficiently store and transmit data by compressing the data prior to storage or transmission. Individual units of compressed data are generally inaccessible directly. While transmission and storage of compressed data is more efficient, compressed data needs to be uncompressed for access to individual units of the data.

Compression techniques are generally divided into lossy compression and lossless compression. Lossy compression achieves greater compression ratios than attained by lossless compression, but lossy compression, followed by uncompression, results in loss of information. For audio signals, data loss resulting from a lossy compression/uncompression cycle needs to be managed to avoid perceptible degradation of the compressed/uncompressed audio signal. By exploiting the inherent limitations of the human auditory system, it is possible to compress and uncompress audio signals without sacrificing sound quality. Since perceptual phenomena are often best understood and represented in the frequency domain, most of the high-quality audio coding systems involve frequency decomposition.

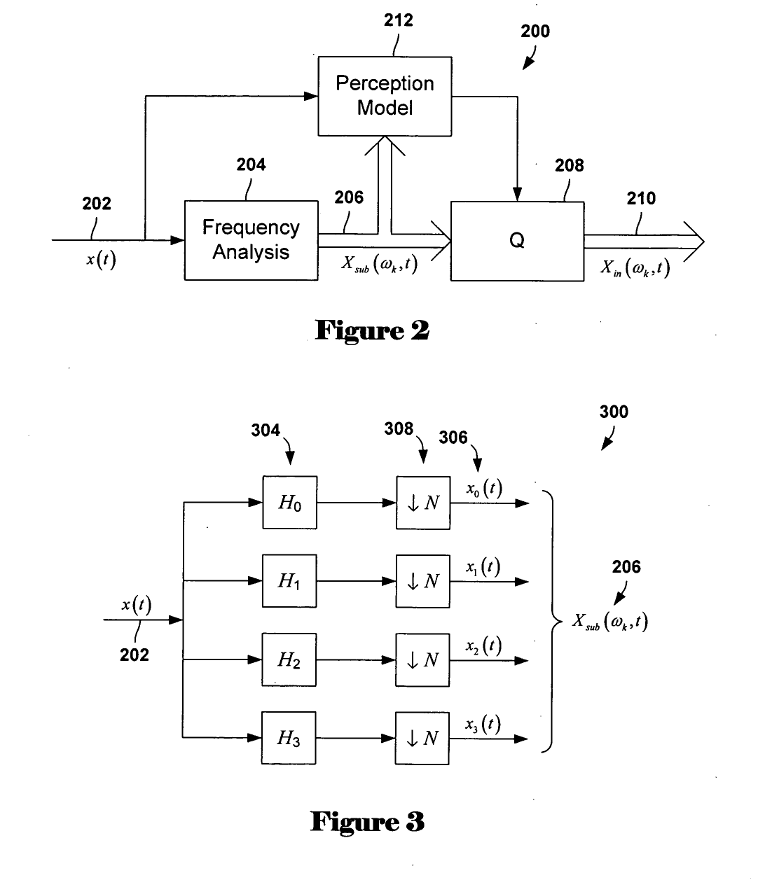

FIG. 2 shows a block diagram depicting the general structure of a frequency-domain audio coder. Block diagram 200 shows a process for coding a single sampled time waveform x(t) 202 into a digital data stream that is a function of both time and frequency. Some examples of such audio coding systems include MPEG-2 and AAC. In FIG. 2, time waveform x(t) 202 is shown input to a block 204 labeled “frequency analysis.” The frequency-analysis block 204 obtains a time-varying frequency analysis of the input time waveform x(t) 202. A time-shifting block transform or a filter bank can be used to perform the time-varying frequency analysis. When, for example, a filter bank is utilized, the filter bank outputs a collective set of N outputs that form a vector time signal X_{sub}(ωₖ, t) 206 with k=0, 1, 2, . . . , N−1 at each time t. The subscript “sub” is used with reference to several different signals in FIG. 2 and in subsequent figures to denote that the signal is a collection of subbands. In FIG. 2, vector signal X_{sub}(ωₖ,t) 206 is represented as a broad arrow. In FIG. 2 and in subsequent figures, signals that are both a function of time and frequency are shown as broad arrows.

Vector signal X_{sub}(ωₖ,t) 206 is input to a block 208 labeled “Q” where vector signal Xᵢₙ(ωₖ,t) 206 is quantized and encoded and output as signal Xᵢₙ(ωₖ,t) 210. It is well established in the field of signal processing that sounds at a particular frequency can be rendered inaudible, or “masked,” by louder sounds at nearby frequencies. In FIG. 2, time waveform x(t) 202 is input to a block 212 labeled “perception model” that computes masking effects to guide the quantization of the frequency analysis using an ancillary fine-grained spectrum analysis. Using this model of audio perception, imperceptible frequency components are given few or no bits, while the frequency components that are most perceptible are given the most bits.

FIG. 3 shows a filter bank system suitable for performing frequency analysis of audio signals in the frequency-domain audio coder shown in FIG. 2. In FIG. 3, time waveform x(t) 202 is shown being input to filter bank 300 and output as a collective set of N outputs that form a vector time signal X_{sub} (ωₖ,t) 206 with k=0, 1, 2, . . . , N−1. Filter bank 300 includes N bandpass filters Gₖ 304, with center frequencies ωₖ, whose passbands cover the desired band of audio frequencies to be represented. Although FIG. 3 shows the case of N=4, typical values are generally N=32 or more. The outputs xₖ(t) 306 of the bandpass filters 304 are time signals that have been downsampled 308 by a factor of N so that the total number of samples/second remains constant.

Two types of masking are generally considered: (1) spatial masking, and (2) temporal masking. In spatial masking, a low-intensity sound is masked by a simultaneously-occurring high-intensity sound. The closer the two sounds are in frequency, the lower the difference in sound intensity needed to mask the low-intensity sound. In temporal masking, a low-intensity sound is masked by a high-intensity sound when the low-intensity sound is transmitted shortly before or shortly after transmission of the high-intensity sound. The closer the two sounds are in time, the lower the difference in sound intensity needed to mask the low-intensity sound.

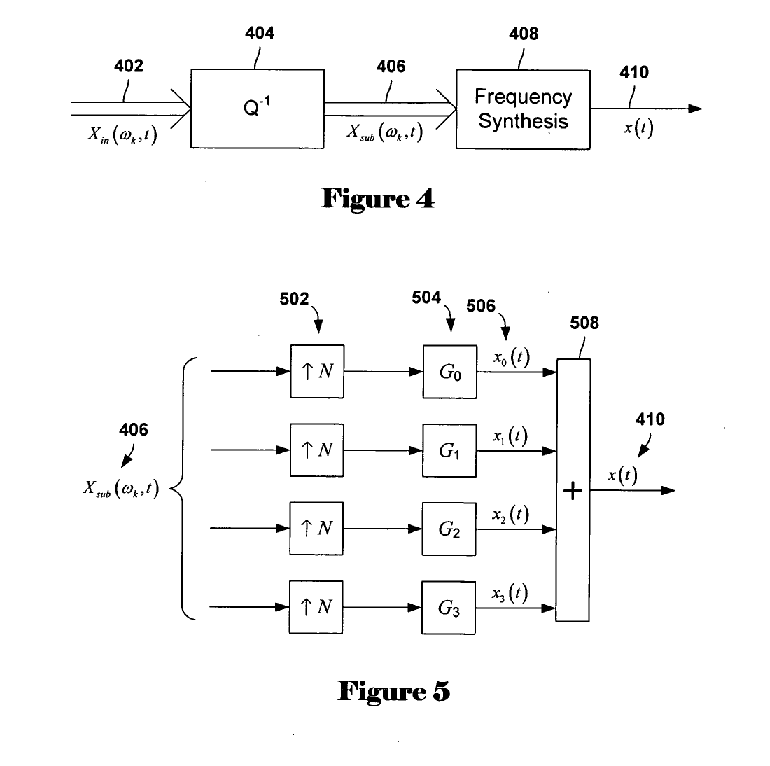

Typically, frequency-domain encoding systems have a corresponding frequency-domain decoding system. FIG. 4 shows a block diagram depicting the general structure of a frequency-domain audio decoder suitable for use with the frequency-domain audio coder shown in FIG. 2. In FIG. 4, signal Xᵢₙ(ωₖ,t) 402 is input to a block 404 labeled “Q⁻¹” that takes encoded digital data and converts the data back into a set of appropriate inputs for frequency synthesis. In FIG. 4, frequency-domain-encoded signal X_{sub}(ωₖ,t) 406 with k=0, 1, 2, . . . , N−1 is output from Q⁻¹ block 404 and input to a block 406 labeled “frequency synthesis” where signal X_{sub}(ωₖ,t) 406 with k=0, 1, 2, . . . , N−1 is reconstructed to a sampled audio time waveform x(t) 410.

FIG. 5 shows a filter bank system suitable for performing frequency synthesis of audio signals in the frequency-domain audio decoder shown in FIG. 4. The collective set of signals X_{sub}(ωₖ,t) 406 with k=0, 1, 2, . . . , N−1 are upsampled 502 and passed through N bandpass filters Gₖ 504, with center frequencies ωₖ, whose passbands cover the desired band of audio frequencies to be represented. The outputs xₖ(t) 506 are summed 508 to reconstruct sampled audio time waveform x(t) 410. With proper design of the bandpass filters 504 and fine quantization of the original frequency analysis data, sampled audio time waveform x(t) 410 can be reconstructed with only a very small amount of error.

### Frequency-Domain-Acoustic-Echo-Canceller Embodiments of the Present Invention

In audio-conference communication systems employing digital transmission, it is common to reduce the bit rate needed for high quality audio transmission by compressing audio signals by using a frequency-domain coder/decoder, such as MPEG-2-and-AAC-based frequency-domain coder/decoders. Audio signals are first passed through a frequency-domain coder prior to transmission, and subsequently passed through a frequency-domain decoder upon reception. The frequency-domain coder converts an outgoing audio signal into a compressed digital audio signal before transmitting the audio signal, and the frequency-domain decoder uncompresses the received, compressed, digital audio signal to restore an analog, audio signal that can be passed to a loudspeaker.

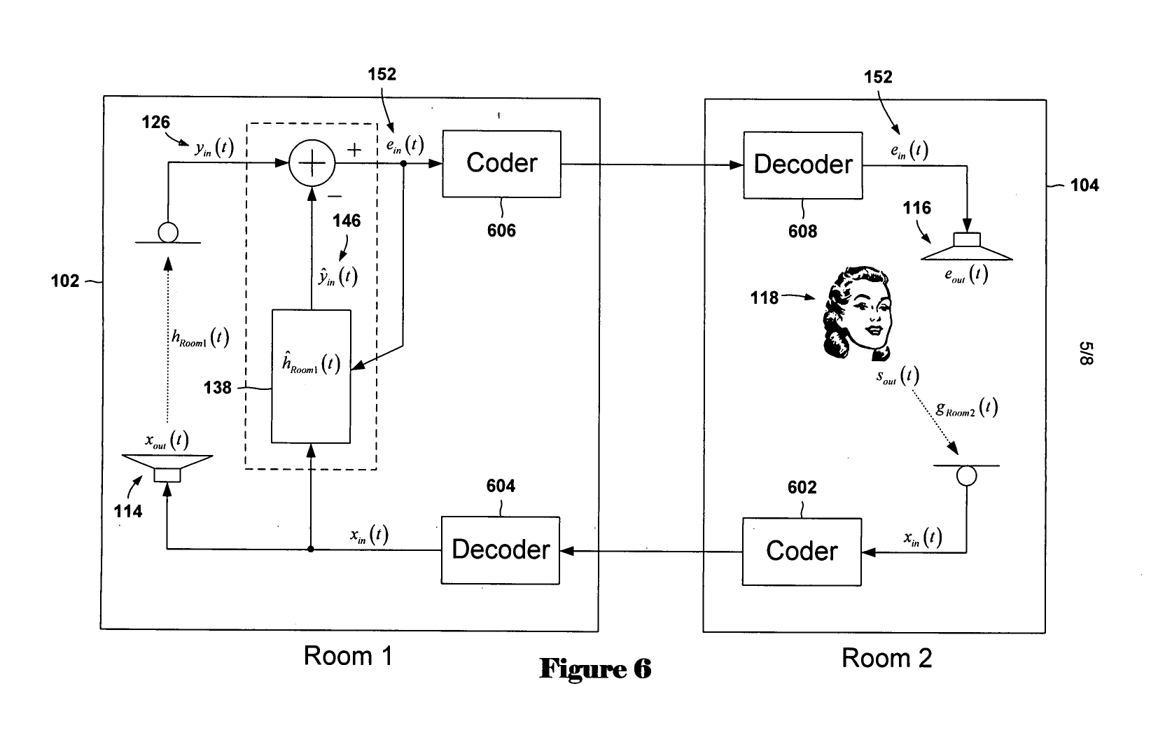

FIG. 6 shows a schematic diagram of the exemplary, two-location, audio-conference communication system shown in FIGS. 1A-1B employing an acoustic echo canceller and a frequency-domain coder/decoder. Frequency-domain coder 602 in Room 2 104 digitizes and compresses an audio signal originating from audio-signal source 118 and transmits the compressed, digital audio signal to frequency-domain decoder 604 in Room 1 102. Frequency-domain decoder 604 restores the analog audio signal by uncompressing the received, compressed, digital audio signal, and the restored audio signal is passed in discrete-time form to adaptive filter 138 and also converted to analog form before passing to loudspeaker 114. Echo estimate signal ŷᵢₙ(t) 146 is subtracted from echo signal yᵢₙ(t) 126 and the resulting error audio signal eᵢₙ(t) 152 is passed to frequency-domain coder 606 in Room 1 102. Error audio signal eᵢₙ(t) 152 is digitized, compressed, and transmitted to frequency-domain decoder 608 in Room 2 104, where error audio signal eᵢₙ(t) 152 is restored to a discrete-time signal, converted to analog form, and passed to loudspeaker 116.

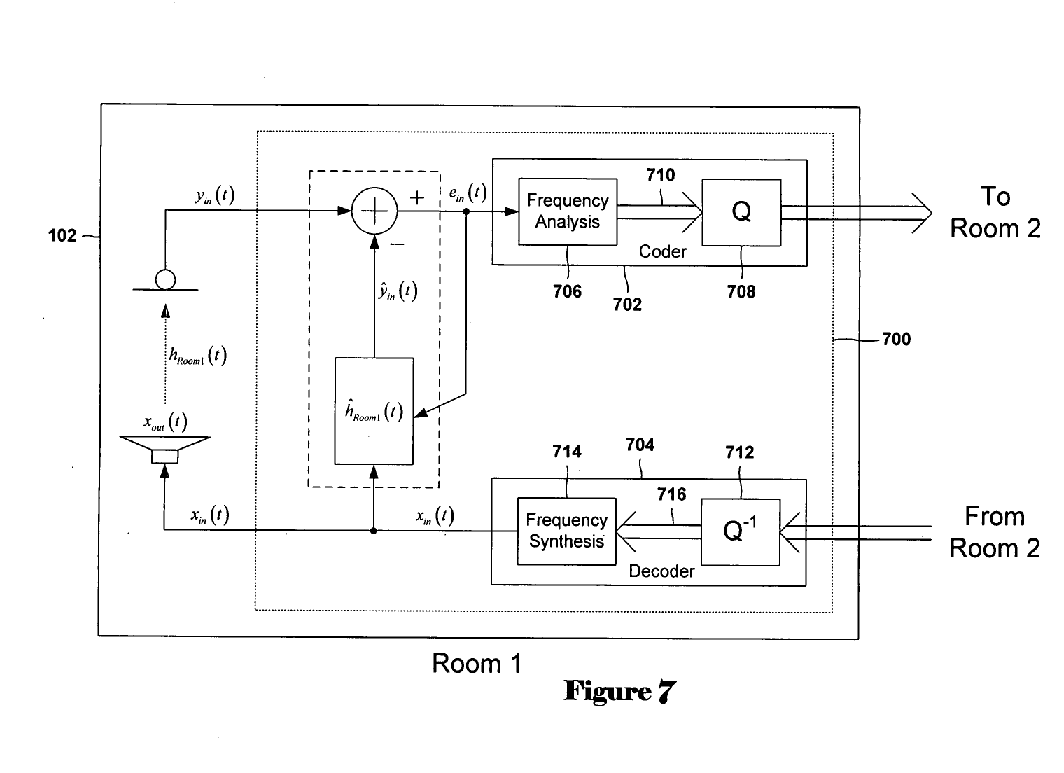

FIG. 7 shows a more detailed schematic diagram of Room 1 of the exemplary, two-location, frequency-domain-coder/decoder-based audio-conference communication system shown in FIG. 6. Frequency-domain coder/decoder 700, shown in Room 1 102 as a dotted rectangle, includes frequency-domain coder 702 and frequency-domain decoder 704. Frequency-domain coder 702 digitizes and compresses audio signals before the audio signals are transmitted to Room 2, and frequency-domain decoder 704 restores audio signals received from Room 2 by uncompressing the received, compressed, digital, audio signal.

As previously shown in FIG. 2, frequency-domain coder 702 shown in FIG. 7 includes frequency analysis stage 706 and quantizer 708, which is controlled by a perceptual model (not shown in FIG. 7). Frequency analysis stage 706 transforms input audio signals into the frequency domain by employing an array of bandpass filters, or a filter bank similar to the filter bank shown in FIG. 3, to separate input audio signals into a number of quasi-bandlimited signals 710, or subbands, shown collectively as a broad arrow. Each subband contains a frequency subset of the entire frequency range of the input audio signal. The isolated frequency components in each subband 710 are passed to quantizer 708 where the subbands are quantized and encoded. The subbands are quantized so that the quantization error is masked by strong audio signal components. As depicted in FIG. 2, perceptual coding is used to discard bits of information within the audio signal in a manner designed to reduce the data rate of the audio signal without increasing the perceived distortion when the signal is reconstructed to a single audio waveform. The perceptual model computation has been omitted to simplify the schematic diagram shown in FIG. 7. However, a perceptual model computation is typically used to control the quantizer. The signal is coded using variable bit allocations, with generally more bits per sample being used in the mid frequency range, where human hearing is most sensitive, to give a finer resolution in the mid frequency range.

The compressed digital audio signal is then transmitted to a frequency-domain decoder in Room 2, where the compressed audio signal can be restored. In Room 1 102, decoder 704 performs the inverse operation on compressed input audio signals from Room 2. Decoder 704 includes unquantizer 712, in which received quantized audio signals are unquantized to create subbands 716, shown collectively as a broad arrow, at the appropriate common-amplitude scale. The subbands are passed to frequency synthesis stage 714, where the subbands are frequency-shifted by upsampling to the original frequency-band locations, passed through a filter bank, summed to a single audio waveform, and transformed back into the time domain as shown, for example, in FIG. 5. Note that the analysis and synthesis filter banks and the compression and uncompression routines performed by the frequency-domain coder/decoder introduce delay into the audio conference communication system.

Various embodiments of the present invention are directed to a frequency-domain coder/decoder for an audio-conference communication system that includes acoustic-echo-canceller functionality. Acoustic echoes are cancelled while divided into a series of subbands in a frequency-domain coder/decoder incorporated into an audio-conference communication system. Acoustic echo cancellation can be performed in the frequency domain since convolution is a linear operation and the frequency analysis and frequency synthesis stages also utilize linear operators. By integrating acoustic echo cancellation into a frequency-domain coder/decoder, acoustic echo cancellation can be performed in the frequency domain without the need for providing redundant audio-signal-transforming equipment for the acoustic echo canceller.

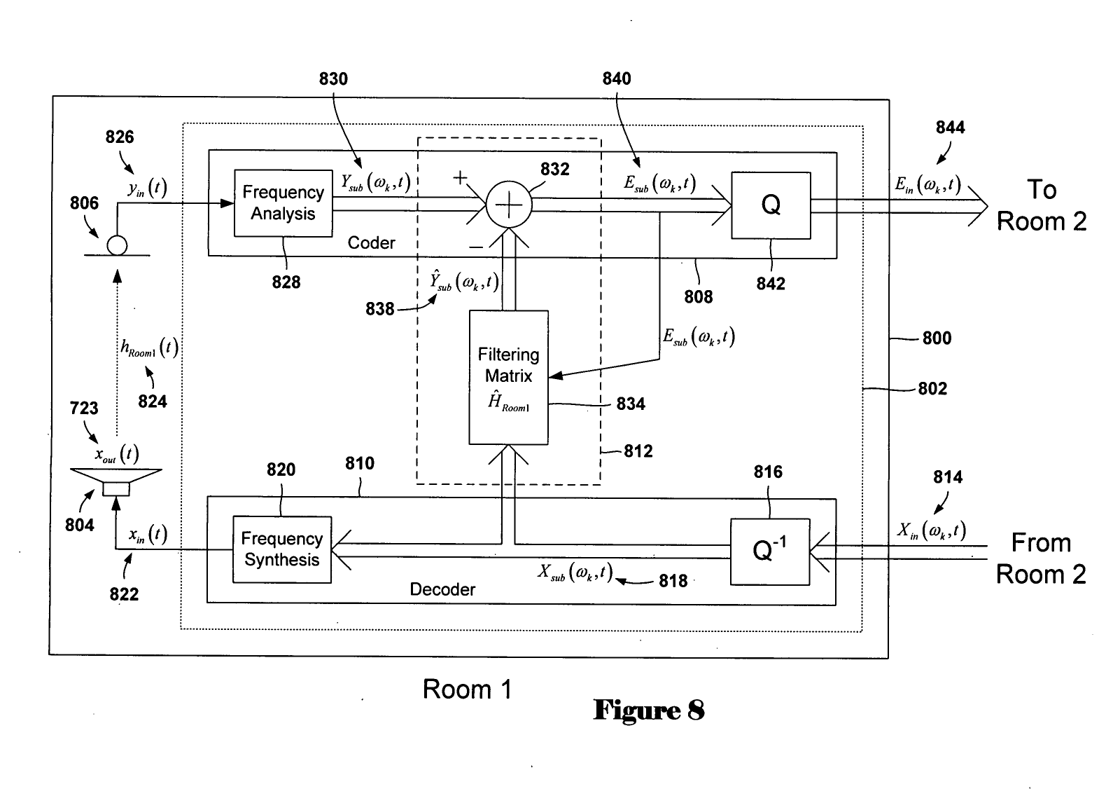

In the present invention, an acoustic echo canceller receives audio signals that are divided into a series of subbands, while the subbands are in a frequency-domain decoder in an audio-conference communication system. The acoustic echo canceller outputs a series of subbands to a frequency-domain coder in the audio-conference communication system. FIG. 8 shows a schematic diagram of an acoustic echo canceller that is integrated into a frequency-domain coder/decoder within Room 1 of an exemplary, two-location, audio-conference communication system and that represents one embodiment of the present invention. Room 1 800 includes frequency-domain coder/decoder 802, represented as a dotted rectangle, loudspeaker 804, and microphone 806. Frequency-domain coder/decoder 802 includes frequency-domain coder 808, frequency-domain decoder 810, and acoustic echo canceller 812, represented by a dashed rectangle. Incoming compressed, digital audio signal Xᵢₙ(ωₖ,t) 814 from Room 2 is input to frequency-domain decoder 810. Compressed, digital audio signal Xᵢₙ(ωₖ,t) 814, a frequency-domain audio signal, is received by unquantizer 816 and converted into a series of subband signals, shown in FIG. 8 as subband signal X_{sub}(ωₖ,t) 818.

Audio signal X_{sub}(ωₖ,t) 818 is output to two locations: frequency synthesis stage 820 and acoustic echo canceller 812. Frequency synthesis stage 820 transforms audio signal X_{sub}(ωₖ,t) 818 to audio signal xᵢₙ(t) 822. Note that audio signal X_{sub}(ωₖ,t) 818 is a reconstructed set of bandpass filter outputs, and audio signal xᵢₙ(t) 822 is a single discrete-time-domain signal. Audio signal xᵢₙ(t) 822 is output from frequency-domain decoder 810, passed through a digital-to-audio converter (not shown in FIG. 8) and then passed to loudspeaker 804, and transmitted in Room 1 700 as acoustic signal xₒᵤₜ(t) 823. The output of microphone 806 is echo signal yᵢₙ(t) 826, which is the convolution of audio signal xᵢₙ(t) 822 with impulse response h_{Room1}(t) 824. Echo signal yᵢₙ(t) 826 is input to frequency-domain coder 808, transformed and divided by frequency analysis stage 828 into a series of subbands, or echo signal Y_{sub}(ωₖ,t) 830, and passed to summing junction 832, which represents vector subtraction of N subband signals.

Acoustic echo canceller 812 receives audio signal X_{sub}(ωₖ,t) 818 and applies a set of filters to the subband signals. The set of filters are represented in FIG. 8 by block 834, labeled “Filtering Matrix Ĥ_{Room1}.” The operation of filtering matrix Ĥ_{Room1} 834 is equivalent to the operation of ŷᵢₙ(t)=xᵢₙ(t)*ĥ_{Room1}(t), discussed above with reference to FIG. 1B. The filters represented by filtering matrix Ĥ_{Room1} 834 are applied to the audio signal X_{sub}(ωₖ,t) 818 to create echo signal estimate Ŷ_{sub}(ωₖ,t) 838, which is output from filtering matrix Ĥ_{Room1} 834 and received by vector summing junction 832. Echo signal estimate Ŷ_{sub}(ωₖ,t) 838 is subtracted from echo signal Ŷ_{sub}(ωₖ,t) 830 to produce error audio signal E_{sub}(ωₖ,t) 840, which is passed back into adaptive filter 834 to provide feedback, and also passed to quantizer 842, where error audio signal E_{sub}(ωₖ,t) 840 is quantized and the result denoted as Eᵢₙ(ωₖ,t) 844. Error audio signal Eᵢₙ(ωₖ, t) 844 is output from frequency-domain coder 808 and transmitted to Room 2.

The quantization of the error signal is guided by a perceptual model. The perceptual model is generally controlled by a high-resolution spectrum computed from the signal yᵢₙ(t) 826, since, in the absence of a signal from Room 2, the signal yᵢₙ(t) 826 is exactly the desired signal to be sent to Room 2. Accordingly, signal yᵢₙ(t) 826 needs to be accurately quantized and encoded. In the case that there is not someone speaking in Room 1, it is less important to accurately quantize the signal E_{sub}(ωₖ,t) 840 since signal E_{sub}(ωₖ,t) 840 represents the echo that is desired to be cancelled. In this case, it is still appropriate to use a perceptual model based upon the signal yᵢₙ(t) 826 because the error signal E_{sub}(ωₖ,t) 840 is an attenuated, filtered version of the signal yᵢₙ(t) 826. The quantization operation shown in FIG. 8 affords additional opportunities for enhancing the quality of audio-conference signals. Further masking of a residual acoustic echo can be incorporated by implementing nonlinear echo suppression techniques well known in the art of acoustic echo cancellation on subband signals as part of the quantization process.

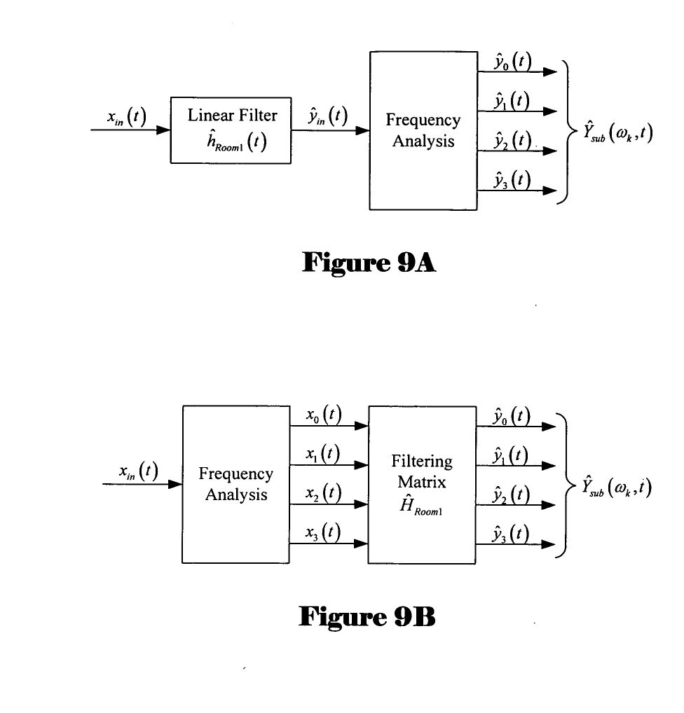

Frequency analysis can be performed either before or after linear filtering. FIG. 9A shows a schematic diagram of linear filtering followed by frequency analysis. In FIG. 9A, frequency analysis is performed after the convolution ŷᵢₙ(t)=xᵢₙ(t)*ĥ_{Room1}(t) to obtain the subband signal Ŷ_{sub}(ωₖ,t). FIG. 9B shows a schematic diagram of frequency analysis followed by linear filtering of the subband signals so that the outputs of FIGS. 9A and 9B are equivalent. In C. A. Lanciani and R. W. Schafer, “Psychoacoustically-based processing of MPEG-I layer 1-2 signals,” IEEE First Workshop on Multimedia Signal Processing, June 1997, pp 53-58 and C. A. Lanciani and R. W. Schafer, “Subband-domain filtering of MPEG audio signals,” Proc. IEEE ICASSP '99, vol. 2, March 1999, pp 917-920, Lanciani and Schafer showed that, when frequency analysis is performed before linear filtering, it is possible to find a set of bandpass filters that can be applied to the subband signals. Determination of this set of linear filters, represented by the filtering matrix Ĥ_{Room} is important to the implementation of the linear filter shown in FIG. 9B. When X_{sub}(ωₖ,t) is input to filtering matrix ĤRoom1, filtering matrix Ĥ_{Room1} can be adjusted so that Ŷ_{sub}(ωₖ, t) obtained in FIG. 9B is equivalent to the result shown in FIG. 9A.

In general, for the output signal of FIG. 9B to be equivalent to the output signal of FIG. 9A, each individual subband of Ŷ_{sub}(ωₖ, t) is dependent upon all of the subbands of X_{sub}(ωₖ,t) to preserve the alias-cancellation property of the analysis/synthesis filter bank system. However, in C. A. Lanciani and R. W. Schafer, “Subband-domain filtering of MPEG audio signals,” Proc. IEEE ICASSP '99, vol. 2, March 1999, pp 917-920, Lanciani and Schafer showed that, for filter banks of the type used in audio coders, it is only necessary to include the effects of adjacent subbands. The impulse responses that comprise the filtering matrix Ĥ_{Room1} can be adapted using techniques well known in the art of acoustic echo cancellation, with the advantages that the bandpass filters operate at a sampling rate that is 1/N times the sampling rate of the audio signal and that the subband signals have relatively flat spectra across their restricted frequency bands.

The audio signal processing performed by a frequency-domain coder/decoder within an audio-conference communication system may also be used to decrease the amount of audible background noise in audio signals before the audio signals are transmitted to a different location. One approach is to employ Wiener-type filtering. Wiener filters separate signals based on the frequency spectra of each signal. Wiener filters pass the frequencies that include mostly audio signal and block the frequencies that include mostly noise. Moreover, the gain of a Wiener filter at each frequency is determined by the relative amount of audio signal and noise at each frequency. The Wiener filter maximizes the signal-to-noise ratio along the audio signal. In order to employ Wiener-type filtering, the signals need to be in the frequency domain and the noise spectra within the current location needs to be known, so that the frequency response of the Wiener filter can be computed. In the current embodiment of the present invention, by utilizing the adaptive filter of the acoustic echo canceller to estimate the noise spectrum at the location in which the frequency-domain coder/decoder is placed, Wiener-type filtering can be performed on audio signals to reduce noise before audio signals are transmitted to another location.

Although the present invention has been described in terms of a particular embodiment, it is not intended that the invention be limited to this embodiment. Modifications within the spirit of the invention will be apparent to those skilled in the art. For example, the number of locations within an audio-conference communication system can be a number larger than two. Two locations are described in many of the examples in the above discussion for clarity of illustration. The number of microphones and loudspeakers used at each location can be varied as well. One microphone and one loudspeaker are used in many examples for clarity of illustration. Multiple microphones and/or loudspeakers can be used at each location. Note that the impulse responses for a location with multiple microphones and loudspeakers may be more complex and, accordingly, more calculations may need to be performed to adjust filtering coefficients to adapt the adaptive filter to changing audio-signal-receiving-location impulse responses.

The foregoing detailed description, for purposes of illustration, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Obviously many modifications and variation are possible in view of the above teachings. The embodiments were chosen and described in order to best explain the principles of the invention and its practical applications and to thereby enable others skilled in the art to best utilize the invention and various embodiments with various modifications as are suited to the particular use contemplated.

1. A frequency-domain-coder/decoder component of an audio-conference communication system in a first location, the frequency-domain-coder/decoder component comprising:
a decoder that converts a quantized frequency-domain audio signal received from a second location to a set of second-location subband signals;
a coder that converts a time-domain echo audio signal received from the first location to a set of first-location frequency-domain echo subband signals;
an acoustic echo canceller that generates a set of frequency-domain error audio subband signals based on the set of second-location subband signals and the set of first-location frequency-domain echo subband signals and that tracks a first-location impulse response based on the generated set of frequency-domain error subband signals; and
an audio signal output that outputs to the second location a quantized frequency-domain error audio subband signal.

2. The frequency-domain-coder/decoder component of claim 1 wherein the decoder includes
an unquantizer for converting the received quantized frequency-domain audio signal received from the second location to the set of second-location subband signals; and
a frequency synthesis stage for converting second-location subband signals to a single sampled audio time-domain waveform.

3. The frequency-domain-coder/decoder component of claim 2 wherein the frequency synthesis stage includes a filter bank.

4. The frequency-domain-coder/decoder component of claim 1 wherein the coder includes
a frequency analysis stage for converting the time-domain echo audio signal received from the first location to the set of first-location frequency-domain echo subband signals input to the acoustic echo canceller; and
a quantizer for converting the set of frequency-domain error audio subband signals generated by the acoustic echo canceller to the quantized frequency-domain error audio subband signal output to the second location.

5. The frequency-domain-coder/decoder component of claim 4 wherein the frequency analysis stage includes a filter bank.

6. The frequency-domain-coder/decoder component of claim 4 wherein the quantizer implements perceptual coding on the set of frequency-domain error audio subband signals before the quantized frequency-domain error audio subband signal is output to the second location.

7. The frequency-domain-coder/decoder component of claim 4 wherein the quantizer implements noise reduction on the set of frequency-domain error audio subband signals before the quantized frequency-domain error audio subband signal is output to the second location.

8. The frequency-domain-coder/decoder component of claim 1 wherein Wiener-type filtering is implemented on the frequency-domain error audio subband signal before the quantized frequency-domain error audio subband signal is output to the second location.

9. The frequency-domain-coder/decoder component of claim 1 wherein the acoustic echo canceller further includes
an adaptive filter that tracks the first-location impulse response based on the generated set of frequency-domain error subband signals and outputs a set of first-location echo subband signal estimates; and
a summing junction that subtracts the received set of first-location echo subband signal estimates from the received set of first-location frequency-domain echo subband signals and outputs the set of frequency-domain error audio subband signals.

10. The frequency-domain-coder/decoder component of claim 9 wherein the adaptive filter includes a set of linear filters.

11. The frequency-domain-coder/decoder component of claim 1 wherein the audio-conference communication system further includes
a number of loudspeakers; and
a number of microphones.

12. A method for canceling acoustic echoes in an audio-conference communication system, the method comprising:
providing a frequency-domain-coder/decoder at a first location, the frequency-domain-coder/decoder including a decoder, a coder, and an acoustic echo canceller;
transmitting from a second location to the decoder a quantized frequency-domain audio signal and converting the quantized frequency-domain audio signal to a set of second-location subband signals;
transmitting from the first location to the coder a time-domain echo audio signal and converting the time-domain echo audio signal to a set of first-location frequency-domain echo subband signals;
generating by the acoustic echo canceller a set of frequency-domain error audio subband signals based on the set of second-location subband signals and the set of first-location frequency-domain echo subband signals and tracking a first-location impulse response based on the generated set of frequency-domain error subband signals; and
outputting to the second location a quantized frequency-domain error audio subband signal.

13. The method of claim 12 wherein the decoder includes
an unquantizer for converting the received quantized frequency-domain audio signal received from the second location to the set of second-location subband signals; and
a frequency synthesis stage for converting second-location subband signals to a single sampled audio time-domain waveform.

14. The method of claim 13 wherein the frequency synthesis stage includes a filter bank.

15. The method of claim 12 wherein the coder includes
a frequency analysis stage for converting the time-domain echo audio signal received from the first location to the set of first-location frequency-domain echo subband signals input to the acoustic echo canceller; and
a quantizer for converting the set of frequency-domain error audio subband signals generated by the acoustic echo canceller to the quantized frequency-domain error audio subband signal output to the second location.

16. The method of claim 15 wherein the frequency analysis stage includes a filter bank.

17. The method of claim 15 wherein the quantizer implements perceptual coding on the set of frequency-domain error audio subband signals before the quantized frequency-domain error audio subband signal is output to the second location.

18. The method of claim 15 wherein the quantizer implements noise reduction on the set of frequency-domain error audio subband signals before the quantized frequency-domain error audio subband signal is output to the second location.

19. The method of claim 12 wherein Wiener-type filtering is implemented on the frequency-domain error audio subband signal before the quantized frequency-domain error audio subband signal is output to the second location.

20. The method of claim 12 wherein the acoustic echo canceller further includes
an adaptive filter that tracks the first-location impulse response based on the generated set of frequency-domain error subband signals and outputs a set of first-location echo subband signal estimates; and
a summing junction that subtracts the received set of first-location echo subband signal estimates from the received set of first-location frequency-domain echo subband signals and outputs the set of frequency-domain error audio subband signals.
